(19) United States
(12) Patent Application Publication
(10) Pub. No.: US 2008/0121127 A1
(43) Pub. Date: May 29, 2008

(54) Gripper base mechanism of sheet-fed printing press

(75) Inventor: Seiji Sasaki, Shizuoka (JP)

Correspondence Address: LADAS & PARRY LLP, 26 WEST 61ST STREET, NEW YORK, NY, 10023, US

(73) Assignee: SHINOHARA MACHINERY CO., LTD.

(21) Appl. No.: 11/998,556

(22) Filed: Nov. 30, 2007

(30) Foreign Application Priority Data
Jun. 12, 2006 (JP) 2006-329083

(51) Int. Cl. B41F 21/00

(52) U.S. Cl. 101/246

(57) ABSTRACT

The present invention aims at providing a gripper-base mechanism which is suitable for automatic and fine adjustment of gripper-base height, superior in durability and easy for manufacturing.

In the gripper-base mechanism according to the invention, rotation displacement means 28 by screw mechanism is disposed between an adjustment shaft 24 which is provided in the radial direction within a sheet transfer cylinder 10 and a gripper-base bar 12 whose height can be adjusted in the radial direction of sheet transfer cylinder 10. A screw-base 32 which composes the rotation displacement means 28 has two male screw portions 38, 40 with oppositely directed thread and is key-jointed with one end of the adjustment shaft 24.

Additionally, a tool receiving portion 46 is formed between two male screw portions 38, 40 and the gripper-base bar 12 is always spring-loaded by a spring member 50 in the direction of the adjustment shaft 24.

### BACKGROUND OF THE INVENTION

1. Field of the Invention

The present invention relates generally to sheet-fed printing press, or more precisely, to gripper-base mechanism for adjusting gripper-base height of sheet transfer cylinder in compliance with sheet thickness.

2. Description of the Prior Art

In a sheet feeder unit or printing units of sheet-fed printing press, there are many sorts of sheet transfer cylinders such as intermediate cylinder or perfecting cylinder and gripper-base must be provided at the circumference of cylinders for gripping and transferring sheets with grippers which are driven harmoniously.

In accordance with the change of sheet thickness to be printed, height of gripper-base which is a receiver of grippers must be adjusted and, if not adequately adjusted, fatal printing impediments such as register error or fan-out will inevitably be caused.

Apparatus for adjusting gripper-base height is disclosed in Japanese patent No. 2779136 in which an adjustment shaft is moved in a radial direction of cylinder by a motor disposed at the end of cylinder axis in order to shift a slide wedge which is parallel to the cylinder axis. But, such slide wedge method narrowly allows very strict manufacturing precision and, on top of that, fine height adjustment is difficult.

In Japanese published patent application No. 29586/1996, plurality of gripper-bases provided at the circumference of the cylinder are adjusted all together by adjustment discs on both sides of the cylinder. But, the technique is substantially a manual operation.

Further in Japanese patent laid-open No. 2004-216623, a cam axis for height adjustment is disposed under a gripper-base bar and is rotated by an appropriate link mechanism. But, such cam shaft is difficult in manufacturing, as it narrowly allows strict precision.

### SUMMARY OF THE INVENTION

Upon consideration of the above-mentioned problems of prior art techniques, the present invention aims at providing an improved gripper-base mechanism which is suitable for automatic and fine adjustment of gripper-base height, superior in durability and easy for manufacturing.

To achieve the objects, gripper-base mechanism comprises rotation displacement means by screw mechanism which is disposed between an adjustment shaft provided in the radial direction within a sheet transfer cylinder and a gripper-base bar whose height can be adjusted in the radial direction of sheet transfer cylinder.

By adopting rotation displacement means which is substantially composed by screw mechanism, reliability as well as durability of system can be improved with increased accuracy and fine adjustability together with easier manufacturing.

The above and other objects of the invention will become apparent from the following description of preferred embodiment taken in conjunction with the accompanying drawings. However, the following description is only an embodiment of the invention and the present invention is not limited to the embodiment.

### BRIEF DESCRIPTION OF THE DRAWINGS

FIG. 1 is a cross-sectional view of sheet transfer cylinder with gripper-base mechanism according to the present invention;

FIG. 2 is an enlarged cross-sectional view of gripper-base mechanism;

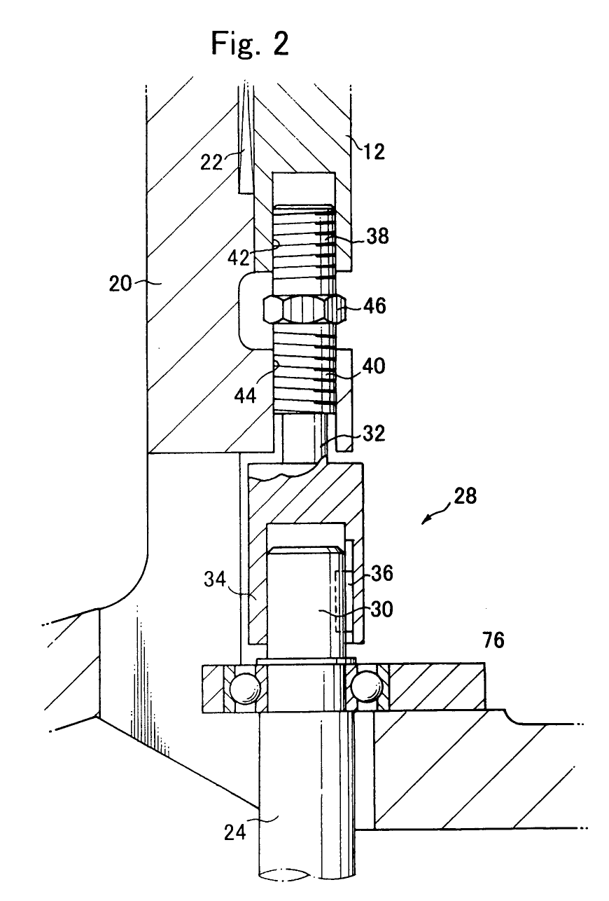

FIG. 3 is a partially enlarged cross-sectional view of gripper-base mechanism;

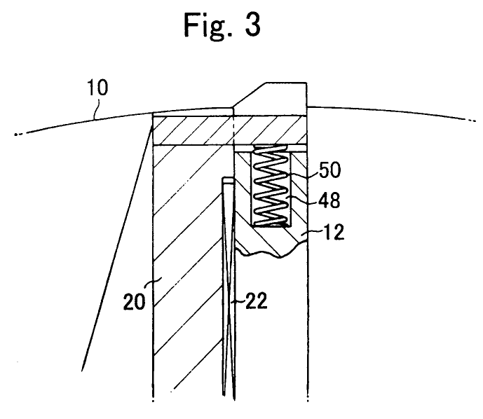

FIG. 4 is a cross-sectional view showing an example of construction for transmitting drive force to adjustment shaft; and

FIG. 5 is also a cross-sectional view showing a portion in succession to that of FIG. 4.

### DESCRIPTION OF THE PREFERRED EMBODIMENT

An embodiment of gripper-base mechanism according to the present invention will be detailed herein-under with reference to the accompanying drawings.

As is already mentioned, sheet transfer cylinder 10 with gripper-base mechanism according to the present invention may be sheet transfer cylinder of feeder unit or intermediate cylinder and perfecting cylinder of printing units. Generally speaking in sheet-fed printing press, the diameter of such sheet transfer cylinder 10 is equal or multiple (for example twice) to that of plate cylinder, therefore, in such multiple case, a number of gripper-base bars 12 to be adjusted by the present invention will evenly be provided at the circumference of sheet transfer cylinder 10.

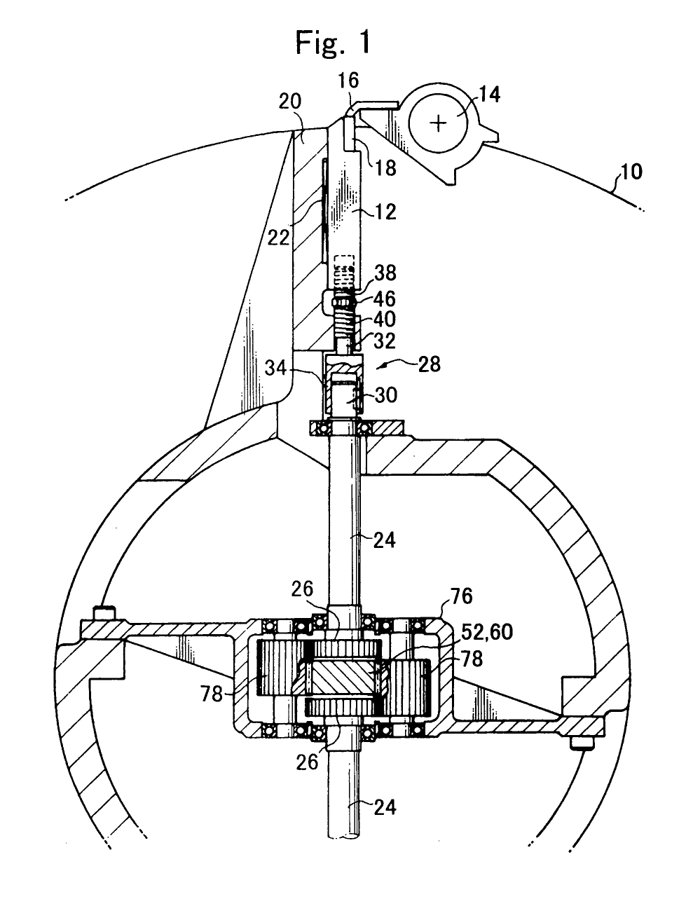

In FIG. 1, gripper axis 14 is provided in parallel to the center of cylinder (perpendicular to FIG. 1) at the groove-like cut portion on the circumference of sheet transfer cylinder 10 and numbers of grippers 16 are aligned on the gripper axis 14. Gripper-base 18 for receiving these grippers 16 is fixed to the gripper-base bar 12 in order to grip sheet end. Accordingly, gripper-base bar 12 is also a long member in parallel to the center of cylinder and the height of it is to be adjusted in the radial direction of cylinder (vertical direction of FIG. 1) along wall surface 20 of groove-like cut portion with the aid of bearing member 22 by, for example, flat roller.

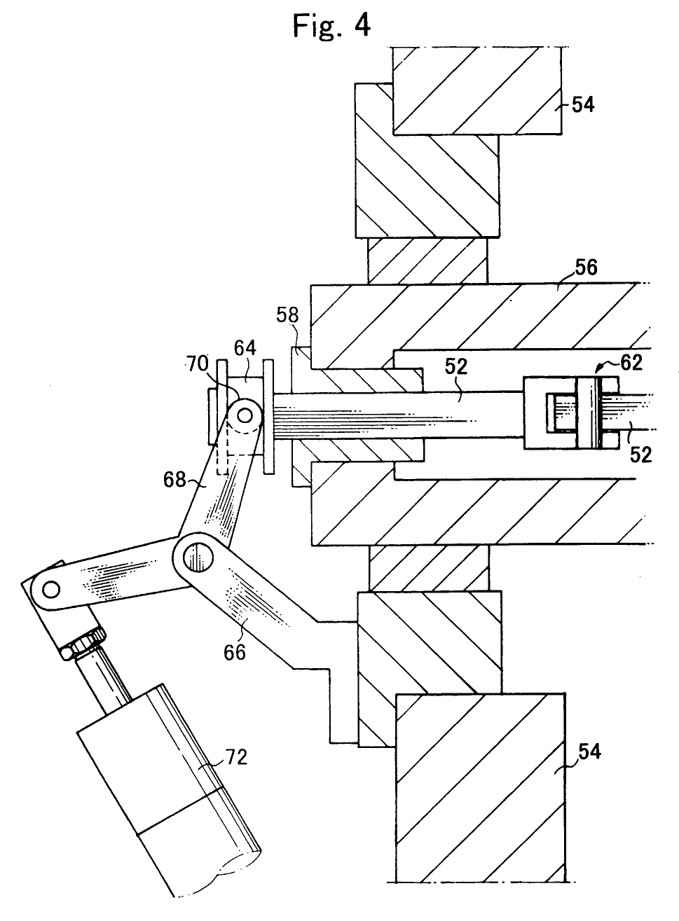

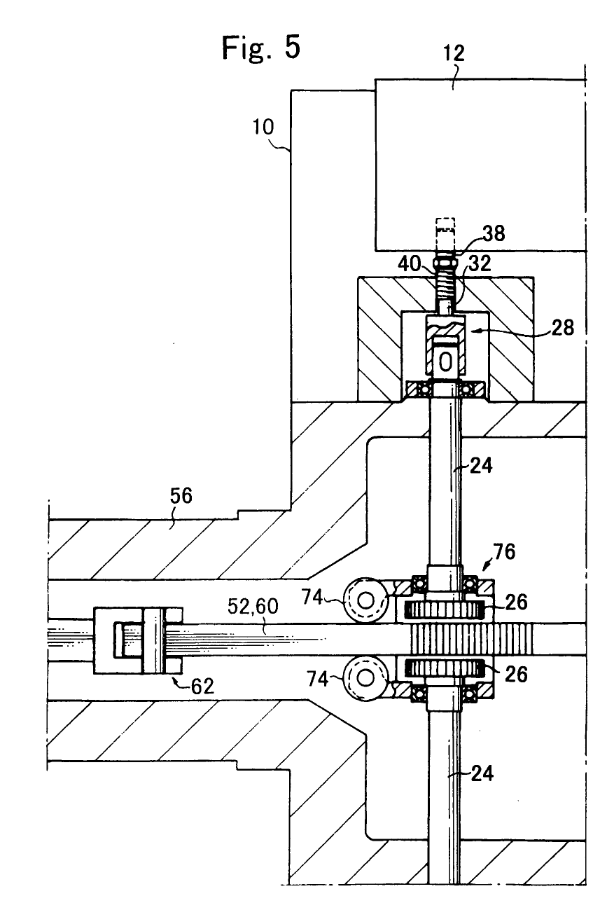

Adjustment shaft 24 is provided in the radial direction of cylinder 10 from the center to the circumference of it and, as herein-under described with FIGS. 4 and 5, receives drive force by gear 26 at one end and is in conjunction with gripper-base bar 12 by way of rotation displacement means 28 at the other end.

The rotation displacement means 28 is by screw mechanism and the upper insert portion 30 of adjustment shaft 24 is fit in the lower insert portion 34 of screw-base 32 and is coupled by key 36. Thereby, screw-base 32 is united with the adjustment shaft 24 in the rotation direction, but slide-free in the vertical direction.

The screw-base 32 has the first male screw portion 38 at the upper half and the second male screw portion 40 at the lower half whose threads are oppositely directed. The first male screw portion 38 at the upper half is in conjunction with female screw portion 42 of gripper-base bar 12 and the second male screw portion 40 at the lower side is in conjunction with female screw portion 44 at the wall surface 20 of cylinder 10.

In the middle of two male screw portions 38, 40, hexagonal tool receiving portion 46 is formed for the convenience of assembly and adjustment by a tool such as a wrench.

A number of holes 48 are drilled at the gripper-base bar 12 along cylinder width. Spring member 50 is disposed for always loading gripper-base bar 12 to the direction of adjustment shaft 24, in other words, to the direction of the center of cylinder 10. The spring member 50 is for canceling the force of gripper-base bar 12 to the external direction due to the centrifugal force of the rotation of cylinder 10 as well as for eliminating the influence of back-lash which is inevitable in screw mechanism.

Rotation force brought by adjustment shaft 24 through rotation displacement means 28 of screw mechanism is transmitted to screw-base 32. As the screw-base 32 is rotated together, but slide-free in the vertical direction, consequently, linear displacement of twice of screw pitch is brought to gripper-base bar 12 so as to adjust the height of gripper-base 18 in the radial direction of cylinder.

By adopting rotation displacement means 28 of screw mechanism, gripper-base mechanism according to the invention can endure perpetual shock by open and close movement of grippers 16 definitely and securely. In addition, height adjustment is correct, because the amount of displacement is twice of screw pitch. Moreover, the mechanism is suitable for fine adjustment, as the amount of height adjustment is considerably small in comparison to the amount of rotation of adjustment shaft 24 by the movement of operation shaft 52. Further, the coupling force of screw mechanism is great and the mechanism is for all-purpose and easy in manufacturing. The screw mechanism may well be a differential screw.

Many mechanisms are conceivable for transmitting drive force to adjustment shaft 24, but they are not the main purpose of the present invention, so only an example is briefly described herein-under with reference to FIGS. 4 and 5.

Cylinder axis 56 of sheet transfer cylinder 10 is freely supported between side frames 54 of both sides of sheet-fed printing press and harmoniously driven by drive source of printing press through various gear connections. The center of cylinder axis 56 and cylinder itself is vacant and linear operation shaft 56 is movably supported by bearing 58 in the direction of cylinder axis (horizontal direction of FIGS. 4 and 5). Operation shaft 52 which is co-centered with cylinder axis 56 is formed in the shape of rack portion 60 at a proper position in the direction of cylinder axis and ordinal round-shaped portion is connected by coupling 62.

Rotation engagement portion 64 by round groove is provided at the extruded end of operation shaft 52 from cylinder axis 56. Crank arm 68 is supported swing-free by a bracket 66 which is fixed to side frame 54. Roller 70 on one end of crank arm 68 is engaged with the rotation engagement portion 64 and, to the other end of crank arm 68, drive means such as by air cylinder or motor is connected. These drive means 72 and operation shaft 52 are always connected mechanically, therefore, clutch mechanism or position sensor for gripper-base 18 are not at all needed.

The rack portion 60 of operation shaft 52 is introduced into a support box 76 at a proposition of adjustment shaft 24 with the guidance of support bearing 74. (So, FIG. 1 is eventually a view from the left side of FIG. 5)

In the support box 76, rotation-free pinion gear 78 engages with the rack 60 of operation shaft 52 and the pinion gear 78 further engages with a gear 26 at the end of adjustment shaft 24.

Therefore, in case height adjustment of gripper-base is needed in compliance with the change of sheet thickness, drive means 72 is activated so as to move the operation shaft 52 in the direction of cylinder axis by way of crank arm 68 and rotation engagement portion 64.

Linear movement of operation shaft 52 is transformed into drive force of adjustment shaft 24 through rack 60, pinion gear 78 and gear 26 of adjustment shaft 24.

In case two adjustment shaft 24 are provided symmetrically in the vertical direction just as shown in FIG. 1, oppositely-directed drive force will arise in the upper and lower adjustment shaft 24, thereby, the same screw mechanism can be applied to both shafts.

The present invention is not limited to the embodiment described above; it can be extended and modified variously.

### DESCRIPTION OF THE REFERENCE NUMERALS

10 sheet transfer cylinder
12 gripper-base bar
16 gripper
18 gripper-base
24 adjustment shaft
26 gear
28 rotation displacement means
30 in-let portion
32 screw-base
34 in-let portion
36 key
38 first male screw portion
40 second male screw portion
42 female screw portion
44 female screw portion
46 tool receiving portion
50 spring member
52 operation shaft
60 rack portion
64 rotation engagement portion
72 drive means
76 support box
78 pinion gear

What is claimed is:

1. In a gripper-base mechanism of sheet-fed printing press where the height of gripper-base bar 12 is adjusted in the radial direction of sheet transfer cylinder 10 by an adjustment shaft 24 provided in the radial direction within said sheet transfer cylinder 10 and rotated by drive force:
wherein a rotation displacement means 28 by screw mechanism is disposed between said adjustment shaft 24 and gripper-base bar 12.

2. Gripper-base mechanism according to claim 1, wherein a screw-base 32 which composes the rotation displacement means 28 has two male screw portions 38, 40 with oppositely directed thread and is key-jointed with one end of the adjustment shaft 24.

3. Gripper-base mechanism according to claim 2, wherein a tool receiving portion 46 is formed between two male screw portions 38, 40.

4. Gripper-base mechanism according to claim 1, wherein the gripper-base bar 12 is always spring-loaded by a spring member 50 in the direction of the adjustment shaft 24.
